(19) United States
(12) Patent Application Publication
(10) Pub. No.: US 2019/0246457 A1
(43) Pub. Date: Aug. 8, 2019

(54) INFRARED HEATER

(71) Applicants: NGK INSULATORS, LTD., Nagoya-City (JP); National University Corporation Hokkaido University, Sapporo-Shi (JP); National University Corporation Niigata University, Niigata-City (JP)

(72) Inventors: Michiro AOKI, Obu-City (JP); Yoshio Kondo, Nagoya-City (JP); Tsuyoshi Totani, Sapporo-Shi (JP); Atsushi Sakurai, Niigata-City (JP)

(73) Assignees: NGK INSULATORS, LTD., Nagoya-City (JP); National University Corporation Hokkaido University, Sapporo-Shi (JP); National University Corporation Niigata University, Niigata-City (JP)

(21) Appl. No.: 16/386,621

(22) Filed: Apr. 17, 2019

Related U.S. Application Data
(63) Continuation of application No. PCT/JP2017/037742, filed on Oct. 18, 2017.

(30) Foreign Application Priority Data
Oct. 24, 2016 (JP) 2016-207571

(51) Int. Cl. H05B 3/12; H05B 3/00

(52) U.S. Cl. CPC H05B 3/12; H05B 2203/032; H05B 3/0038

(57) ABSTRACT

An infrared heater includes a heater body and a casing. The heater body includes a heating element and a metamaterial structure capable of emitting infrared radiation having a peak wavelength of a non-Planck distribution when thermal energy is supplied from the heating element. The casing has an interior space in which the heater body is disposed and whose pressure is reducible. In addition, the casing includes an infrared radiation transmitting portion capable of transmitting the infrared radiation emitted by the metamaterial structure to an outside of the casing.

### BACKGROUND OF THE INVENTION

### 1. Field of the Invention

The present invention relates to an infrared heater.

### 2. Description of the Related Art

Infrared heaters having various structures have been known. For example, PTL 1 describes a flat heater including a support plate and a ribbon-shaped heating element wound around the support plate. PTL 2 discloses an infrared heater including a heating element and a microcavity body in which microcavities are formed. At least surfaces of the microcavities are formed of a conductor. The infrared heater described in PTL 2 is configured such that the microcavity body absorbs energy emitted from the heating element and emits infrared radiation having a peak wavelength of a non-Planck distribution. Accordingly, infrared radiation in a specific wavelength range can be emitted toward an object. A structure such as the microcavity body that emits infrared radiation in a specific wavelength range is referred to as a metamaterial structure.

### CITATION LIST

### Patent Literature

PTL 1: Japanese Unexamined Patent Application Publication No. 2006-261095

PTL 2: Japanese Unexamined Patent Application Publication No. 2015-198063

### SUMMARY OF THE INVENTION

When an infrared heater includes a metamaterial structure as described in PTL 2, the infrared emissivity is relatively low in a wavelength range other than the specific wavelength range. Therefore, compared to, for example, a normal infrared heater that does not include the metamaterial structure as described in PTL 1, the temperature of the infrared heater including the metamaterial structure itself is more easily increased when the same electric power is supplied. Since the temperature is easily increased, convective heat transfer easily occurs between the infrared heater and the ambient gas. Accordingly, convective loss is increased and the energy efficiency is easily reduced.

The present invention has been made to solve the above-described problem, and a main object of the present invention is to increase the energy efficiency of an infrared heater including a metamaterial structure.

To achieve the above-described main object, the present invention has the following structure.

An infrared heater of the present invention includes:

a heater body including a heating element and a metamaterial structure capable of emitting infrared radiation having a peak wavelength of a non-Planck distribution when thermal energy is supplied from the heating element; and

a casing having an interior space in which the heater body is disposed and whose pressure is reducible, the casing including an infrared radiation transmitting portion capable of transmitting the infrared radiation emitted by the metamaterial structure to an outside of the casing.

In this infrared heater, the heater body including the heating element and the metamaterial structure is disposed in the interior space of the casing whose pressure is reducible. Therefore, when the infrared heater is used while the pressure in the interior space is reduced, the convective heat transfer from the heater body to the interior space is less than, for example, when the pressure in the interior space is a normal pressure. Accordingly, the convective loss can be reduced. As a result, the energy efficiency of the infrared heater can be increased. The metamaterial structure may be a structure having radiation characteristics such that the maximum peak is sharper than the peak of a Planck distribution. Here, the expression “sharper than the peak of the Planck distribution” means that “half-width (full width at half maximum (FWHM)) is smaller than that of the peak of the Planck distribution”.

The infrared heater according to the present invention may further include an infrared radiation reflecting portion disposed apart from the heater body and capable of reflecting the infrared radiation toward at least one of the heater body and the object. In such a case, at least part of the energy of the infrared radiation emitted by the heater body can be reflected and supplied to at least one of the heater body and the object, and the energy efficiency is further increased. In this case, the infrared radiation reflecting portion may be disposed on an inner peripheral surface of the casing that is exposed in the interior space.

In the infrared heater according to the present invention including the infrared radiation reflecting portion, the casing may include an infrared radiation transmitting member capable of transmitting the infrared radiation, and the infrared radiation reflecting portion may be disposed outside the casing. Also in this case, at least part of the energy of the infrared radiation emitted by the heater body can be reflected and supplied to at least one of the heater body and the object. In this case, the infrared radiation reflecting portion may be disposed on an outer peripheral surface of the casing.

In the infrared heater according to the present invention, the heater body may include a low radiation layer that is disposed on a surface of the heater body at a side opposite to a side at which the metamaterial structure is disposed when viewed from the heating element, the low radiation layer having an average emissivity lower than an average emissivity of the metamaterial structure. In such a case, the amount of energy of the infrared radiation emitted in a direction away from the metamaterial structure when viewed from the heating element can be reduced, and the energy efficiency is further increased.

In the infrared heater according to the present invention, the metamaterial structure may include a first conductor layer, a dielectric layer joined to the first conductor layer, and a second conductor layer in that order from the heating element, the second conductor layer including a plurality of individual conductor layers that are each joined to the dielectric layer and that are periodically arranged with gaps therebetween.

In the infrared heater according to the present invention, the metamaterial structure may have a plurality of microcavities, at least surfaces of which are formed of a conductor and which are periodically arranged with gaps therebetween.

### BRIEF DESCRIPTION OF THE DRAWINGS

FIG. 1 is a schematic sectional view of an infrared heater 10.

FIG. 2 is a partial bottom view of a metamaterial structure 30.

FIG. 3 is a partial sectional view of a heater body 11A according to a modification.

FIG. 4 is a partial bottom perspective view of a metamaterial structure 30A according to the modification.

FIG. 5 is a sectional view of an infrared heater 110 according to another modification.

FIG. 6 is another sectional view of the infrared heater 110 according to the modification.

FIG. 7 is a graph showing the relationship between the electric power supplied to a heating element 13 and the temperature of a heater body.

### DETAILED DESCRIPTION OF THE INVENTION

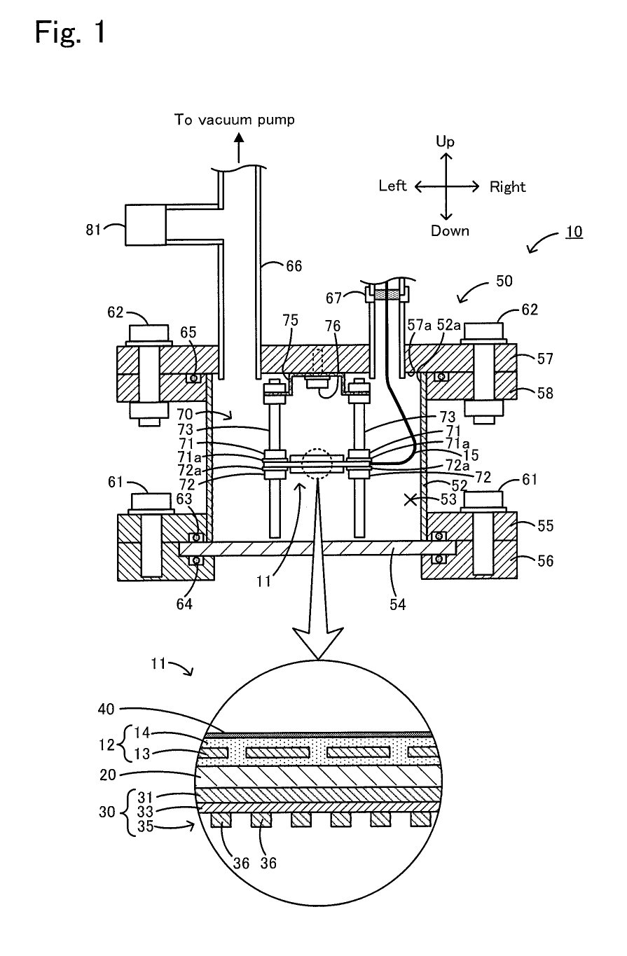

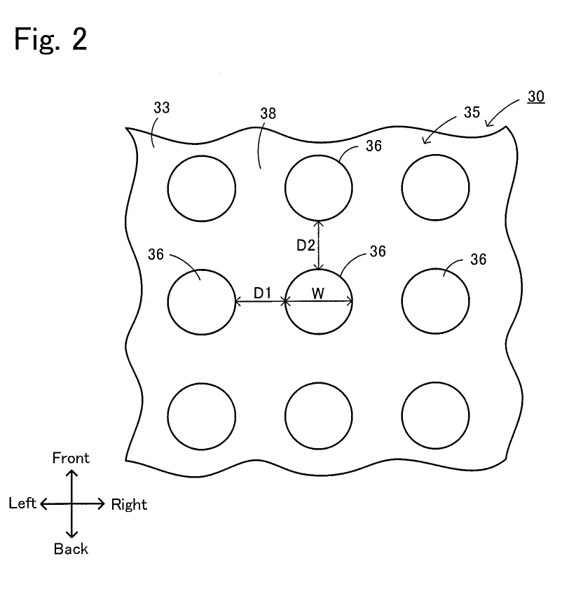

An embodiment of the present invention will now be described with reference to the drawings. FIG. 1 is a schematic sectional view of an infrared heater 10 according to an embodiment of the present invention. FIG. 2 is a partial bottom view of a metamaterial structure 30. In the present embodiment, a left-right direction, a front-back direction, and an up-down direction are defined as illustrated in FIGS. 1 and 2. The infrared heater 10 includes a heater body 11, a casing 50, and a fixing portion 70. The heater body 11 and the fixing portion 70 are disposed in an interior space 53 of the casing 50. The infrared heater 10 emits infrared radiation toward an object (not shown) disposed therebelow.

The heater body 11 is disposed in the interior space 53 of the casing 50. As illustrated in the enlarged view shown in FIG. 1, the heater body 11 includes a heating portion 12, a support substrate 20 disposed below the heating portion 12, the metamaterial structure 30 disposed below the support substrate 20, and a low radiation layer 40 disposed above the heating portion 12.

The heating portion 12 is configured as a so-called flat heater, and includes a heating element 13 including a line-shaped member bent in a zig-zag manner and a protective member 14 composed of an insulator disposed in contact with the heating element 13 to cover the periphery of the heating element 13. The material of the heating element 13 may be, for example, W, Mo, Ta, Fe—Cr—Al alloy, or Ni—Cr alloy. The material of the protective member 14 may be, for example, an insulating resin, such as polyimide, or a ceramic. A pair of electric wires 15 (only one electric wire 15 is illustrated in FIG. 1) are attached to both ends of the heating element 13. The electric wires 15 extend to the outside of the infrared heater 10 through a sealing gland 67 attached to an upper portion of the casing 50. Electric power can be supplied to the heating element 13 from the outside through the electric wires 15. The heating portion 12 may instead be a flat heater configured such that a ribbon-shaped heating element is wound around an insulator. Although the heating portion 12 has a rectangular shape in top view, the heating portion 12 may instead have, for example, a circular shape.

The support substrate 20 is a flat-plate-shaped member disposed below the heating portion 12. The support substrate 20 is fixed to the fixing portion 70 disposed in the casing 50, and supports the heating portion 12 and the metamaterial structure 30. The support substrate 20 may be composed of, for example, a material such as a Si wafer or glass whose surface can be easily maintained smooth, which is highly heat resistant, and which is not easily thermally warped. In the present embodiment, the support substrate 20 is a Si wafer. The support substrate 20 may either be in contact with the bottom surface of the heating portion 12 as in the present embodiment, or be spaced and separated from the heating portion 12 in the up-down direction. When the support substrate 20 and the heating portion 12 are in contact with each other, the support substrate 20 and the heating portion 12 may be joined together.

The metamaterial structure 30 is a plate-shaped member disposed below the heating element 13 and the support substrate 20. The metamaterial structure 30 may be joined to the bottom surface of the support substrate 20 as necessary either directly or with an adhesive layer (not shown) provided therebetween. The metamaterial structure 30 includes a first conductor layer 31, a dielectric layer 33, and a second conductor layer 35, which includes a plurality of individual conductor layers 36, in that order in a downward direction from the heating element 13. The layers of the metamaterial structure 30 may be joined together either directly or with adhesive layers provided therebetween. The metamaterial structure 30 is disposed such that the bottom surface thereof faces an infrared radiation transmitting plate 54 of the casing 50. Bottom exposed portions of the individual conductor layers 36 and the dielectric layer 33 may be coated with an oxidation resistant layer (not shown and made of, for example, alumina).

The first conductor layer 31 is a flat-plate-shaped member joined to the support substrate 20 at a side (bottom side) opposite to the side at which the heating element 13 is provided. The material of the first conductor layer 31 may be, for example, a conductor (electrical conductor), such as a metal. Examples of the metal include gold, aluminum (Al), and molybdenum (Mo). In the present embodiment, the material of the first conductor layer 31 is gold. The first conductor layer 31 is joined to the support substrate 20 with an adhesive layer (not shown) provided therebetween. The material of the adhesive layer may be, for example, chromium (Cr), titanium (Ti), or ruthenium (Ru). The first conductor layer 31 and the support substrate 20 may instead be joined directly to each other.

The dielectric layer 33 is a flat-plate-shaped member joined to the first conductor layer 31 at a side (bottom side) opposite to the side at which the heating element 13 is provided. The dielectric layer 33 is disposed between the first conductor layer 31 and the second conductor layer 35. The material of the dielectric layer 33 may be, for example, alumina (Al₂O₃) or silica (SiO₂). In the present embodiment, the material of the dielectric layer 33 is alumina.

The second conductor layer 35 is a layer composed of a conductor, and has a periodic structure in directions along the bottom surface of the dielectric layer 33 (front-back and left-right directions). More specifically, the second conductor layer 35 includes the individual conductor layers 36, and the individual conductor layers 36 are arranged with gaps therebetween in the directions along the bottom surface of the dielectric layer 33 (front-back and left-right directions) to form the periodic structure (see FIG. 2). The individual conductor layers 36 are arranged at equal intervals and separated from each other by a gap D1 in the left-right direction (first direction). The individual conductor layers 36 are also arranged at equal intervals and separated from each other by a gap D2 in the front-back direction (second direction) orthogonal to the left-right direction. Thus, the individual conductor layers 36 are arranged in a grid pattern. Although the individual conductor layers 36 are arranged in a rectangular grid pattern in the present embodiment as illustrated in FIG. 2, the individual conductor layers 36 may instead be arranged in, for example, a hexagonal grid pattern such that the individual conductor layers 36 are at the vertices of regular triangles. Each of the individual conductor layers 36 is circular in bottom view, and has a cylindrical shape with a thickness h (height in the up-down direction) less than a diameter W thereof. The period of the periodic structure of the second conductor layer 35 is Λ1=D1+W in the horizontal direction and Λ2=D2+W in the vertical direction. In the present embodiment, D1=D2. Therefore, Λ1=Λ2. The material of the second conductor layer 35 (individual conductor layers 36) may be a conductor, such as a metal, and may be a material similar to that of the above-described first conductor layer 31. At least one of the first conductor layer 31 and the second conductor layer 35 may be made of a metal. In the present embodiment, the material of the second conductor layer 35 is gold, which is the same as the material of the first conductor layer 31.

As described above, the metamaterial structure 30 includes the first conductor layer 31, the second conductor layer 35 (individual conductor layers 36) having the periodic structure, and the dielectric layer 33 disposed between the first conductor layer 31 and the second conductor layer 35. This configuration enables the metamaterial structure 30 to emit infrared radiation having a peak wavelength of a non-Planck distribution when thermal energy is supplied thereto from the heating element 13. A Planck distribution is a bell-shaped distribution having a specific peak on a graph having the horizontal axis representing the wavelength that increases toward the right and the vertical axis representing the radiation intensity. The Planck distribution is represented by a curve having a steep slope on the left side of the peak and a gentle slope on the right side of the peak. An ordinary material emits radiation in accordance with this curve (Planck's radiation curve). Non-Planck radiation (infrared radiation having a peak wavelength of a non-Planck distribution) is radiation represented by a bell-shaped curve that is sharper than that of the Planck's radiation in a range having a maximum peak at the center. More specifically, the radiation characteristics of the metamaterial structure 30 are such that the maximum peak thereof is sharper than the peak of the Planck distribution. Here, the expression “sharper than the peak of the Planck distribution” means that “half-width (full width at half maximum (FWHM)) is smaller than that of the peak of the Planck distribution”. Accordingly, the metamaterial structure 30 functions as a metamaterial emitter having such characteristics as to selectively emit infrared radiation having a specific wavelength in the entire infrared wavelength range (0.7 μm to 1000 μm). It is considered that these characteristics derive from a resonance phenomenon that can be explained by a magnetic polariton. The magnetic polariton is a resonance phenomenon in which antiparallel currents are excited in two upper and lower conductors (first conductor layer 31 and second conductor layer 35) and in which a strong magnetic field confinement effect is generated in a dielectric (dielectric layer 33) between the conductors. Accordingly, a locally strong electric field vibration is excited in the first conductor layer 31 and the individual conductor layers 36 of the metamaterial structure 30, and this serves as a source of infrared radiation. The infrared radiation is emitted into the ambient environment (especially downward in this embodiment). According to the metamaterial structure 30, the resonant wavelength can be adjusted by changing the materials of the first conductor layer 31, the dielectric layer 33, and the second conductor layer 35 and adjusting the shape and the periodic structure of the individual conductor layers 36. Thus, the first conductor layer 31 and the individual conductor layers 36 of the metamaterial structure 30 emit infrared radiation such that the infrared emissivity is high at a specific wavelength. In other words, the metamaterial structure 30 has such characteristics as to emit infrared radiation having a sharp maximum peak with a relatively small half-width and a relatively high emissivity. Although D1=D2 in the present embodiment, the gaps D1 and D2 may differ from each other. This also applies to the periods Λ1 and Λ2. The half-width can be controlled by changing the periods Λ1 and Λ2. The wavelength at the above-described maximum peak of the predetermined radiation characteristics of the metamaterial structure 30 may be in the range of greater than or equal to 6 μm and less than or equal to 7 μm, or in the range of greater than or equal to 2.5 μm and less than or equal to 3.5 μm. The infrared emissivity of the metamaterial structure 30 in the wavelength range other than the wavelength range from the rising edge to the falling edge of the maximum peak is preferably less than or equal to 0.2. The metamaterial structure 30 is preferably configured such that the half-width of the maximum peak is less than or equal to 1.0 μm. The radiation characteristics of the metamaterial structure 30 may be substantially symmetrical about a vertical line that passes through the maximum peak. The height of the maximum peak (maximum radiation intensity) of the metamaterial structure 30 does not exceed the height of the Planck's radiation curve.

The above-described metamaterial structure 30 may be formed by, for example, the following method. First, an adhesive layer and the first conductor layer 31 are formed in that order on a surface (bottom surface in FIG. 1) of the support substrate 20 by sputtering. Next, the dielectric layer 33 is formed on a surface (bottom surface in FIG. 1) of the first conductor layer 31 by the atomic layer deposition (ALD) method. Subsequently, a predetermined resist pattern is formed on a surface (bottom surface in FIG. 1) of the dielectric layer 33, and then a layer made of the material of the second conductor layer 35 is formed by helicon sputtering. Then, the resist pattern is removed so that the second conductor layer 35 (individual conductor layers 36) is formed.

The low radiation layer 40 is disposed on a surface (top surface in FIG. 1) of the heater body 11 at a side opposite to the side at which the metamaterial structure 30 is provided when viewed from the heating element 13. The low radiation layer 40 has an average emissivity lower than the average emissivity of the metamaterial structure 30. The term “average emissivity” means the average of emissivities in the entire infrared wavelength range (0.7 μm to 1000 μm). Therefore, the low radiation layer 40 may have a wavelength range in which the emissivity thereof is higher than that of the metamaterial structure 30 as long as the low radiation layer 40 has a lower overall emissivity. The average emissivities of the metamaterial structure 30 and the low radiation layer 40 are determined based on the emissivities at the same temperature. The low radiation layer 40 is preferably made of a low emissivity material. The material of the low radiation layer 40 may be, for example, gold or aluminum (Al). In the present embodiment, the low radiation layer 40 is made of gold. The low radiation layer 40 may be formed on a surface (top surface in this example) of the protective member 14 by, for example, sputtering.

The casing 50 includes a hollow cylindrical portion 52, the infrared radiation transmitting plate 54 (example of an infrared radiation transmitting portion), clamping members 55 and 56, and plate-shaped members 57 and 58. The hollow cylindrical portion 52 has an axial direction that extends in the up-down direction, and is open at the top and bottom ends thereof. The infrared radiation transmitting plate 54 is disposed to block the opening at the bottom end of the hollow cylindrical portion 52. The infrared radiation transmitting plate 54 serves as a window through which the infrared radiation from the metamaterial structure 30 are transmitted to the outside of the casing 50. The infrared radiation transmitting plate 54 is capable of transmitting at least some of the infrared radiation emitted from the metamaterial structure 30 that are in a wavelength range from the rising edge to the falling edge of the maximum peak of the infrared radiation. The infrared radiation transmitting plate 54 is preferably capable of transmitting at least part of the infrared radiation emitted from the metamaterial structure 30 that is in a wavelength range including the maximum peak, and more preferably capable of transmitting at least part of the emitted infrared radiation in a wavelength range including the half-width range around the maximum peak. The material of the infrared radiation transmitting plate 54 may be, for example, quartz (which transmits infrared radiation having a wavelength of 3.5 μm or less), transparent alumina (which transmits infrared radiation having a wavelength of 5.5 μm or less), or fluorite (calcium fluoride, CaF₂, which transmits infrared radiation having a wavelength of 8 μm or less). The material of the infrared radiation transmitting plate 54 may be selected as appropriate in accordance with the maximum peak of the infrared radiation emitted from the metamaterial structure 30. The casing 50 has the interior space 53 surrounded by the hollow cylindrical portion 52, the plate-shaped member 57, and the infrared radiation transmitting plate 54. The clamping members 55 and 56, which are plate-shaped members having circular openings in top view, clamp the infrared radiation transmitting plate 54 from above and below in a region outside the hollow cylindrical portion 52 to fix the infrared radiation transmitting plate 54. Sealing members 63 and 64, such as O-rings, are disposed between the infrared radiation transmitting plate 54 and the clamping members 55 and 56 to seal the interior space 53 from the outside of the casing 50. The clamping members 55 and 56 are pressed against each other in the up-down direction and fixed by a plurality of fixing members 61 (only two fixing members 61 are illustrated in FIG. 1), such as bolts. The plate-shaped members 57 and 58 are circular plate-shaped members in top view. The plate-shaped member 57 is disposed to block the opening at the top end of the hollow cylindrical portion 52, and a bottom surface 57a of the plate-shaped member 57 is exposed to the interior space 53. The plate-shaped member 58 has a circular opening in top view, and the top end of the hollow cylindrical portion 52 is inserted in this opening. A sealing member 65, such as an O-ring, is disposed between the plate-shaped members 57 and 58. The plate-shaped members 57 and 58 are pressed against each other in the up-down direction and fixed by a plurality of fixing members 62 (only two fixing members 62 are illustrated in FIG. 1). Each fixing member 62 includes, for example, a bolt and a nut.

The materials of the hollow cylindrical portion 52, the clamping members 55 and 56, and the plate-shaped members 57 and 58 may be, for example, stainless steel or aluminum. Among the members of the casing 50 that define the interior space 53, the members other than the infrared radiation transmitting plate 54 (the hollow cylindrical portion 52 and the plate-shaped member 57 in this embodiment) are preferably made of a material capable of reflecting infrared radiation. More specifically, among the surfaces of the casing 50 that are exposed in the interior space 53, the surfaces of the members other than the infrared radiation transmitting plate 54 (examples of an infrared radiation reflecting portion; the cylindrical inner surface 52a and the bottom surface 57a in this embodiment) preferably have particularly high infrared reflectances. For example, the cylindrical inner surface 52a and the bottom surface 57a may have infrared reflectances of 50% or higher, 80% or higher, or 90% or higher. In the present embodiment, the hollow cylindrical portion 52 and the plate-shaped member 57 are made of stainless steel, and the cylindrical inner surface 52a and the bottom surface 57a are polished by, for example, buff polishing to increase the reflectances thereof. The cylindrical inner surface 52a is a side surface that is exposed in the interior space 53 of the casing 50 (surface surrounding the heater body 11 in the front-back and left-right directions). The bottom surface 57a is a ceiling surface that is exposed in the interior space 53 of the casing 50 and that is at a side (upper side in this case) opposite to the side at which the metamaterial structure 30 is provided when viewed from the heating element 13.

A pipe 66 and the sealing gland 67 are attached to the upper portion of the casing 50. The inside of the pipe 66 communicates with the interior space 53 through the through holes formed in the hollow cylindrical portion 52 and the plate-shaped member 57. A vacuum gauge 81 and a vacuum pump (not shown) are connected to the pipe 66. The pressure in the interior space 53 can be reduced by operating the vacuum pump. The sealing gland 67 allows the electric wires 15 to be inserted therethrough so that the electric wires 15 of the heating element 13 extend to the outside while the interior space 53 is sealed from the exterior space.

The fixing portion 70 is a member that supports the heater body 11 in the interior space 53. The fixing portion 70 includes pairs of nuts 71 and 72, spacers 71a and 72a, guide shafts 73, a support plate 75, and a fixing member 76. The nuts 71 and 72 are provided in pairs to clamp the support substrate 20 of the heater body 11 from above and below. The fixing portion 70 includes a plurality of pairs of nuts 71 and 72 (for example, four pairs, only two of which are illustrated in FIG. 1). Each spacer 71a is disposed between one of the nuts 71 and the support substrate 20, and each spacer 72a is disposed between one of the nuts 72 and the support substrate 20. The support substrate 20 is in contact with the nuts 71 and 72 and the guide shafts 73 with the spacers 71a and 72a provided therebetween. To reduce heat conduction from the support substrate 20 to the nuts 71 and 72 and the guide shafts 73, the spacers 71a and 72a are preferably made of a material having a low thermal conductivity (for example, ceramic, glass, or resin). The guide shafts 73 are rod-shaped members that extend through the nuts 71 and 72, the spacers 71a and 72a, and the support substrate 20 to support these components. The number of guide shafts 73 is the same as the number of pairs of nuts 71 and 72 (four guide shafts 73, only two of which are illustrated in FIG. 1, are provided in the present embodiment). The guide shafts 73 are attached and fixed to the plate-shaped member 57 by the support plate 75 and the fixing member 76 that extends through the support plate 75. Thus, the fixing portion 70 supports the heater body 11 in such a manner that the heater body 11 is separated from the casing 50. The support substrate 20 of the heater body 11 is larger than the heating portion 12 and the metamaterial structure 30 in top view, and extends beyond these components in the horizontal direction. Therefore, the guide shafts 73 extend only through the support substrate 20 of the heater body 11. The guide shafts 73 have external threads, so that the nuts 71 and 72 are capable of changing the positions thereof in the up-down direction along the guide shafts 73. Thus, the position of the heater body 11 in the up-down direction (for example, distance to the infrared radiation transmitting plate 54) is changeable.

An example of use of the above-described infrared heater 10 will now be described. First, a predetermined reduced pressure atmosphere is established in the interior space 53 by using the vacuum pump (not shown). The atmosphere in the interior space 53 may be, but not particularly limited to, an air atmosphere or an inert gas atmosphere (for example, nitrogen atmosphere). The pressure in the interior space 53 is reduced to 100 Pa or less. The pressure in the interior space 53 may instead be reduced to a pressure higher than or equal to 0.01 Pa. A power supply (not shown) supplies electric power to both ends of the heating element 13 through the electric wires 15. The electric power is supplied so that, for example, the temperature of the heating element 13 reaches a preset temperature (not particularly limited, and is 320° C. in this embodiment). Energy is transferred from the heating element 13, which is heated to the predetermined temperature, into the ambient environment mainly by conduction among the three types of heat transfer: conduction, convection, and radiation. Thus, the metamaterial structure 30 is heated. As a result, the temperature of the metamaterial structure 30 increases to a predetermined temperature (for example, 300° C. in this embodiment), so that the metamaterial structure 30 serves as a radiator and emits infrared radiation. Since the metamaterial structure 30 includes the first conductor layer 31, the dielectric layer 33, and the second conductor layer 35 as described above, the heater body 11 emits infrared radiation having a peak wavelength of a non-Planck distribution. More specifically, the heater body 11 selectively emits infrared radiation in a specific wavelength range from the first conductor layer 31 and the individual conductor layers 36 of the metamaterial structure 30. The infrared radiation in the specific wavelength range emitted from the first conductor layer 31 and the individual conductor layers 36 are transmitted through the infrared radiation transmitting plate 54 and emitted downward from the infrared heater 10. Thus, the infrared heater 10 is capable of selectively emitting the infrared radiation in the specific wavelength range toward an object disposed below the infrared radiation transmitting plate 54. Accordingly, an object having a relatively high infrared absorptivity in this specific wavelength range, for example, can be efficiently heated by emitting the infrared radiation toward this object.

The infrared heater 10 according to the present embodiment that is described in detail above includes the heater body 11 including the metamaterial structure 30. Therefore, the infrared emissivity is relatively low in a wavelength range other than the specific wavelength range. Therefore, compared to, for example, an ordinary infrared heater that does not include the metamaterial structure 30 and that directly emits infrared radiation from the heating element 13, the temperature of the heater body 11 of the infrared heater 10 more easily increases when the same electric power is supplied. In general, as the temperature of the heater body 11 increases, convective heat transfer between the heater body 11 and the gas in the interior space 53 more easily occurs, and the amount of convective heat transfer from the heater body 11 to the casing 50 increases. Therefore, in general, the infrared heater 10 including the metamaterial structure 30 tends to cause a reduction in the energy efficiency due to convective loss. However, according to the infrared heater 10 of the present embodiment, since the interior space 53 is used after reducing the pressure therein, the amount of convective heat transfer from the heater body 11 to the interior space 53 is less than when the pressure in the interior space 53 is a normal pressure. Accordingly, the convective loss can be reduced. As a result, the energy efficiency of the infrared heater 10 including the metamaterial structure 30 can be increased.

In addition, the infrared heater 10 includes the cylindrical inner surface 52a and the bottom surface 57a, which are disposed apart from the heater body 11 and are capable of reflecting the infrared radiation toward at least one of the heater body 11 and the object. Since the cylindrical inner surface 52a and the bottom surface 57a are capable of reflecting the infrared radiation, at least part of the energy of the infrared radiation emitted by the heater body 11 can be reflected and supplied to at least one of the heater body 11 and the object. Thus, the energy efficiency is further increased.

In addition, the infrared heater 10 includes the heater body 11 including the low radiation layer 40 disposed on a surface (top surface in FIG. 1) of the heater body 11 at a side opposite to the side at which the metamaterial structure 30 is provided when viewed from the heating element 13. The low radiation layer 40 has an average emissivity lower than the average emissivity of the metamaterial structure 30. Therefore, the amount of energy of the infrared radiation emitted from the heating element 13 in a direction away from the metamaterial structure 30 can be reduced, and the energy efficiency is further increased.

The present disclosure is not limited to the above-described embodiment, and can be carried out by various modes as long as they belong to the technical scope of the disclosure.

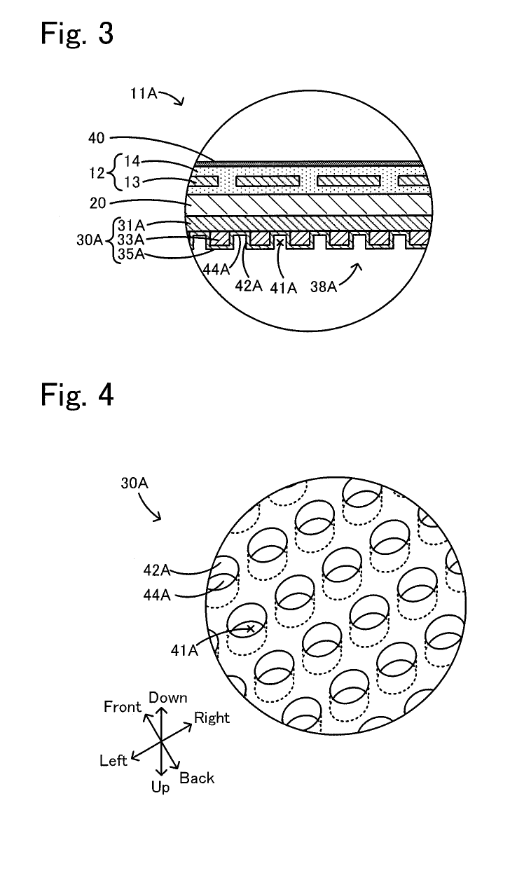

For example, although the metamaterial structure 30 includes the first conductor layer 31, the dielectric layer 33, and the second conductor layer 35 in the above-described embodiment, the metamaterial structure 30 is not limited to this. The metamaterial structure 30 may be any structure that is capable of emitting infrared radiation having a peak wavelength of a non-Planck distribution when thermal energy is supplied thereto from the heating element 13. For example, the metamaterial structure may be configured as a microcavity body in which a plurality of microcavities are formed. FIG. 3 is a partial sectional view of a heater body 11A according to a modification. FIG. 4 is a partial bottom perspective view of a metamaterial structure 30A according to the modification. The heater body 11A includes the metamaterial structure 30A in place of the metamaterial structure 30. The metamaterial structure 30A includes a plurality of microcavities 41A that have a conductor layer 35A at least on surfaces thereof (side surfaces 42A and bottom surfaces 44A in this modification) and that form a periodic structure that is periodic in the front-back and left-right directions. The metamaterial structure 30A includes a main body layer 31A, a recessed layer 33A, and a conductor layer 35A in that order in a downward direction from the heating element 13 of the heater body 11A. The main body layer 31A is composed of, for example, a glass substrate. The recessed layer 33A is made of, for example, a resin or an inorganic material, such as ceramic or glass. The recessed layer 33A is formed on the bottom surface of the main body layer 31A, and has cylindrical recesses formed therein. The recessed layer 33A may be made of the same material as the second conductor layer 35. The conductor layer 35A is provided on a surface (bottom surface) of the metamaterial structure 30A and covers surfaces (bottom and side surfaces) of the recessed layer 33A and the bottom surface of the main body layer 31A (regions where the recessed layer 33A is not provided). The conductor layer 35A is composed of a conductor, and the material thereof may be, for example, a metal, such as gold or nickel, or a conductive resin. The microcavities 41A are substantially cylindrical spaces that are open at the bottom and surrounded by the side surfaces 42A of the conductor layer 35A (portions that cover the side surfaces of the recessed layer 33A) and the bottom surfaces 44A of the conductor layer 35A (portions that cover the bottom surface of the main body layer 31A). As illustrated in FIG. 4, the microcavities 41A are arranged in the front-back and left-right directions. The bottom surface of the metamaterial structure 30A serves as a radiation surface 38A from which the infrared radiation is emitted toward an object. More specifically, when the metamaterial structure 30A absorbs the energy emitted from the heating element 13, infrared radiation having a high intensity in a specific wavelength is emitted toward the object disposed below the radiation surface 38A due to resonance between incident and reflected waves in the spaces defined by the bottom surfaces 44A and the side surfaces 42A. Thus, similar to the metamaterial structure 30, the metamaterial structure 30A is capable of emitting infrared radiation having a peak wavelength of a non-Planck distribution. The radiation characteristics of the metamaterial structure 30A can be adjusted by adjusting the diameter and depth of each of the cylindrical microcavities 41A. The shape of the microcavities 41A is not limited to a cylindrical shape, and may instead be a prismatic shape. The depth of the microcavities 41A may be, for example, greater than or equal to 1.5 μm and less than or equal to 10 μm. Similar to the above-described embodiment, also when the infrared heater 10 includes the heater body 11A, the convective loss of the heater body 11A in use can be reduced and the energy efficiency can be increased by establishing a reduced pressure atmosphere in the interior space 53 in use. The above-described metamaterial structure 30A may be formed by, for example, the following method. First, the recessed layer 33A is formed on the bottom surface of the main body layer 31A by a commonly known nanoimprinting process. Then, the conductor layer 35A is formed to cover the surfaces of the recessed layer 33A and the main body layer 31A by, for example, sputtering.

Although the heater body 11 includes the low radiation layer 40 in the above-described embodiment, the radiation layer 40 may be omitted.

In the above-described embodiment, only the infrared radiation transmitting plate 54 of the casing 50 transmits the infrared radiation from the heater body 11. However, the casing 50 is not limited to this, and the entirety thereof, for example, may serve as an infrared radiation transmitting portion. For example, the casing 50 may have a hollow cylindrical shape, and the entirety of the casing 50 may be formed of the same infrared radiation transmitting material (for example, quartz glass) as the infrared radiation transmitting plate 54. In such a case, the heater body 11 may have a cylindrical shape. More specifically, the heater body 11 may include a cylindrical heating portion 12 and a metamaterial structure 30 provided on a surface of the heating portion 12. When the entirety of the casing 50 is made of an infrared radiation transmitting material, a reflective layer that serves as an infrared radiation reflecting portion may be formed on an outer top surface or a top inner peripheral surface of the casing 50. The material of the reflective layer may be, for example, gold or aluminum. The casing 50 may include two concentric cylindrical tubes. In such a case, the heater body 11 may be disposed in the inner cylindrical tube. Also, a refrigerant (for example, air) may be circulated through the space between the inner cylindrical tube and the outer cylindrical tube to cool the casing 50.

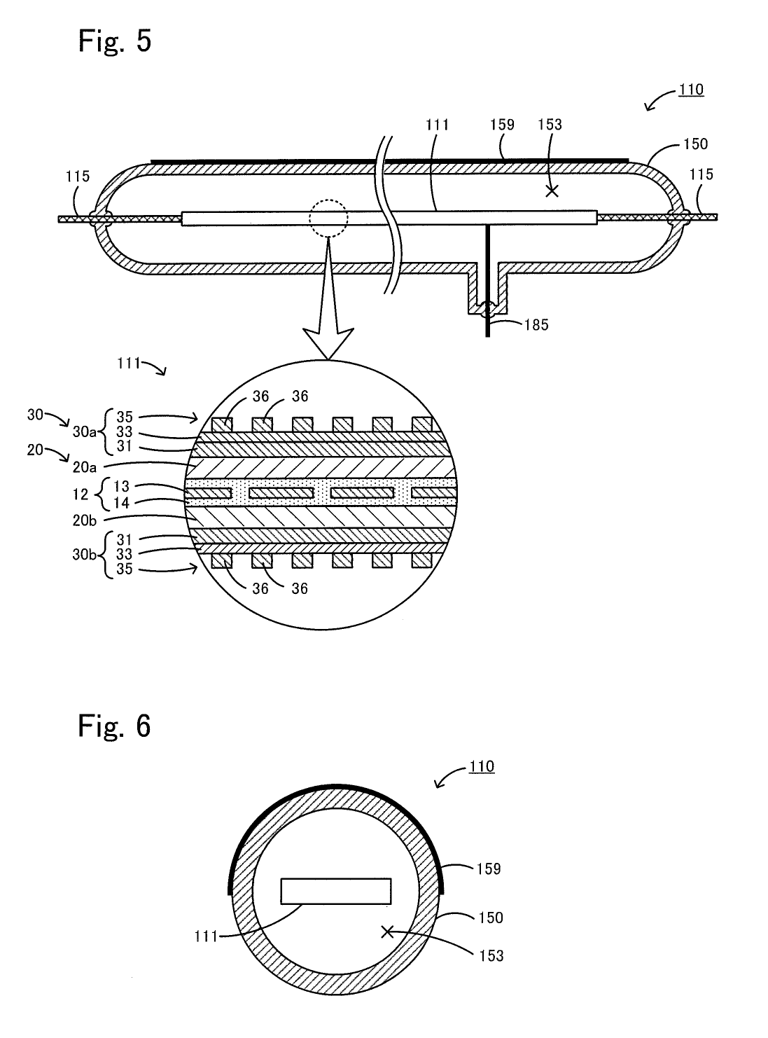

An example in which the casing 50 is made of the same infrared radiation transmitting material as that of the infrared radiation transmitting plate 54 will be described with reference to FIGS. 5 and 6. FIGS. 5 and 6 are sectional views of an infrared heater 110 according to a modification. FIG. 5 is a sectional view taken in the axial direction of a casing 150. FIG. 6 is a sectional view taken in a direction perpendicular to the axial direction of the casing 150. Components of the infrared heater 110 that are the same as those of the infrared heater 10 are denoted by the same reference numerals, and detailed description thereof is omitted. The infrared heater 110 includes a heater body 111, the casing 150, a reflective layer 159, and a thermocouple 185. The heater body 111 is disposed in an interior space 153 of the casing 150, and is flat-plate-shaped. The material of the heating element 13 of the heater body 111 is Kanthal (trademark) (alloy containing iron, chromium, and aluminum). The heater body 111 includes support substrates 20a and 20b, which each function as the support substrate 20, on the top and bottom surfaces of the heating portion 12. The support substrates 20a and 20b are made of quartz glass in this modification. The heater body 111 includes metamaterial structures 30a and 30b, which each function as the metamaterial structure 30, on the top surface of the support substrate 20a and the bottom surface of the support substrate 20b. The configuration of each of the metamaterial structures 30a and 30b is similar to that of the metamaterial structure 30 illustrated in FIG. 1. The metamaterial structure 30a and the metamaterial structure 30b are symmetrical to each other about a plane perpendicular to the up-down direction. The metamaterial structure 30a mainly emits infrared radiation upward, and the metamaterial structure 30b mainly emits infrared radiation downward. Rod-shaped conductors 115, which are electrically connected to the heating portion 12, are attached to both ends of the heater body 111 in the longitudinal direction (left-right direction in FIG. 5). The rod-shaped conductors 115 extend to the outside from both ends of the casing 150 in the axial direction. Electric power can be supplied from the outside to the heating element 13 through the rod-shaped conductors 115. The rod-shaped conductors 115 also have a function of supporting the heater body 111 in the casing 150. The material of the rod-shaped conductors 115 is Mo in this modification. The thermocouple 185, which is an example of a temperature sensor that measures the temperature of the surface of the heater body 111, extends from the surface of the heater body 111 to the outside through the casing 150. Similar to the above-described infrared radiation transmitting plate 54, the casing 150 is made of an infrared radiation transmitting material. In this modification, the casing 150 is made of quartz glass (which transmits infrared radiation having a wavelength of 3.5 μm or less). The casing 150 has a substantially hollow cylindrical shape. The heater body 111 is disposed in the interior space 153 of the casing 150. Both ends of the casing 150 in the axial direction are tapered and curved, and the rod-shaped conductors 115 extend to the outside from the ends of the casing 150. A reduced pressure atmosphere is established in the interior space 153 in advance when the infrared heater 110 is manufactured. Portions of the casing 150 through which the rod-shaped conductors 115 and the thermocouple 185 extend from the interior space 153 to the outside are sealed by melting the casing 150. These portions may instead by sealed by using a sealing material other than the casing 150. The reflective layer 159, which is an example of an infrared radiation reflecting portion, is arranged to cover a portion of the outer peripheral surface of the casing 150. Accordingly, the reflective layer 159 only partially covers the periphery of the heater body 111. The reflective layer 159 is disposed on one side (upper side in FIGS. 5 and 6 in this modification) of the heater body 111 in a direction perpendicular to the longitudinal direction of the casing 150. The reflective layer 159 is disposed on an outer top surface of the casing 150. In this modification, the reflective layer 159 covers the upper half of the outer peripheral surface of the casing 150 (see FIG. 6). The reflective layer 159 is disposed to face the metamaterial structure 30a, and is located in front of the metamaterial structure 30a in the direction in which the infrared radiation is emitted (upward direction in this modification). The material of the reflective layer 159 may be, for example, gold, platinum, or aluminum. In this modification, the reflective layer 159 is made of gold. The reflective layer 159 may be formed on the surface of the casing 150 by a film forming method such as coating and drying, sputtering, CVD, or thermal spraying. In the infrared heater 110 having the above-described structure, the metamaterial structure 30b emits infrared radiation mainly downward, and the emitted infrared radiation is transmitted through the casing 150 and reach an object disposed below the infrared heater 110. Since the pressure in the interior space 153 is reduced, similar to the above-described embodiment, the energy efficiency of the infrared heater 110 is increased. The metamaterial structure 30a emits infrared radiation mainly upward, and the emitted infrared radiation is reflected by the reflective layer 159 and supplied to at least one of the heater body 111 and the object (mainly to the heater body 111 in this modification). Therefore, the energy efficiency of the infrared heater 110 is further increased. The entirety of the casing 150 functions as an infrared radiation transmitting portion. In particular, a portion of the casing 150 at which the reflective layer 159 is not disposed (lower half of the casing 150 in this modification) functions as an infrared radiation transmitting portion, and the infrared radiation can be emitted toward the object from this portion.

The infrared heater 110 according to the above-described modification is configured such that the reflective layer 159 is disposed on the outer peripheral surface of the casing 150. However, the reflective layer 159 is not necessarily disposed on the outer peripheral surface, and may be disposed at any position outside the casing 150. For example, an independent reflective portion may be disposed outside the casing 150 in place of the reflective layer 159.

In the above-described embodiment, among the surfaces of the casing 50 that are exposed in the interior space 53, the surfaces of the members other than the infrared radiation transmitting plate 54 (the cylindrical inner surface 52a and the bottom surface 57a in the above-described embodiment) serve as the infrared radiation reflecting portion. However, the infrared radiation reflecting portion is not limited to this, and may instead be at least portions of the surfaces of the casing 50 that are exposed in the interior space 53. Alternatively, the infrared radiation reflecting portion may be a member other than the casing 50. For example, a reflective layer that serves as the infrared radiation reflecting portion may be formed on at least one of the cylindrical inner surface 52a and the bottom surface 57a. Alternatively, an infrared radiation reflecting portion that is independent of the casing 50 may be disposed between the cylindrical inner surface 52a and the heater body 11 or between the bottom surface 57a and the heater body 11. Alternatively, the infrared heater 10 may include no infrared radiation reflecting portion.

In the above-described embodiment, a reduced pressure atmosphere is established in the interior space 53 by using the pipe 66 attached to the casing 50 and a vacuum pump when the infrared heater 10 is used. However, the infrared heater 10 is not limited to this. For example, the interior space 53 may be sealed from the outside while a reduced pressure atmosphere is established therein when the infrared heater 10 is manufactured. In this case, the pipe 66 attached to the casing 50 may be omitted.

In the above-described embodiment, the heater body 11 is supported by the fixing portion 70 such that the heater body 11 is separated from the casing 50. However, the heater body 11 is not limited to this. For example, the top surface of the heater body 11 (for example, a surface of the heating portion 12 at a side opposite to the side at which the metamaterial structure 30 is provided) may be in contact with the casing 50. In this case, the low radiation layer 40 of the heater body 11 may be omitted. However, the heater body 11 and the casing 50 are preferably separated from each other so that heat conduction therebetween can be reduced and that the energy efficiency can be further increased.

### EXAMPLES

Examples of infrared heaters that were actually manufactured will now be described. The present invention is not limited to the Examples.

### Example 1

The infrared heater 10 having the structure illustrated in FIGS. 1 and 2 except that the heater body 11 does not include the low radiation layer 40 was manufactured. With regard to the materials of the metamaterial structure 30, the first conductor layer 31 and the second conductor layer 35 were made of gold and the dielectric layer 33 was made of alumina. The first conductor layer 31 had a thickness f of 100 nm, the dielectric layer 33 had a thickness d of 176.3 nm, and the second conductor layer 35 (individual conductor layers 36) had a thickness h of 55 nm. The individual conductor layers 36 had a diameter W of 2.16 μm, and the periods Λ1 and Λ2 were both 4.00 μm. The radiation characteristics of the heater body 11 including the manufactured metamaterial structure 30 had a maximum peak at a peak wavelength of 6.7 μm. The inner diameter of the interior space 53 of the casing 50 (that is, the inner diameter of the hollow cylindrical portion 52) was 108 mm, and the height of the interior space 53 in the up-down direction was 85 mm. The infrared radiation transmitting plate 54 had a thickness of 7 mm and was made of quartz glass. A portion to the infrared radiation transmitting plate 54 that was capable of transmitting the infrared radiation (area of a portion that was not clamped by the clamping members 55 and 56) was circular and had a diameter of 108 mm in top view. The cylindrical inner surface 52a and the bottom surface 57a were buff-polished (#400). A vacuum (9.1 Pa) was established in the interior space 53 of the infrared heater 10. Next, electric power was supplied to the heating element 13 until the temperature of the heater body 11 reached 300° C. The electric power supplied when the temperature reached 300° C. was measured and determined to be 18.3 W. The relationship between the supplied electric power and the temperature of the heater body 11 was measured while changing the electric power. As a result, the electric power was 13.5 W at 259° C., and 9.1 W at 207° C. The temperature of the heater body 11 was measured by using a thermocouple brought into contact with the surface of the metamaterial structure 30.

### Comparative Example 1

As Comparative Example 1, a test similar to that in Example 1 was performed by using the same infrared heater 10 as that of Example 1 while the interior space 53 was in an atmospheric atmosphere. In Comparative Example 1, the electric power supplied to the heating element 13 when the temperature of the heater body 11 (metamaterial structure 30) was 300° C. was 36.1 W. The relationship between the supplied electric power and the temperature of the heater body 11 was measured while changing the electric power. As a result, the electric power was 26.7 W at 255° C., 18.7 W at 208° C., and 9.9 W at 140° C.

### Example 2

As Example 2, a test similar to that in Example 1 was performed by using the same infrared heater 10 as that of Example 1 except that the heater body 11 included the low radiation layer 40 while a vacuum (9.1 Pa) was established in the interior space 53. The low radiation layer 40 had a thickness of 11 μm and was made of aluminum. In Example 2, the electric power supplied to the heating element 13 when the temperature of the heater body 11 (metamaterial structure 30) was 300° C. was 13.4 W.

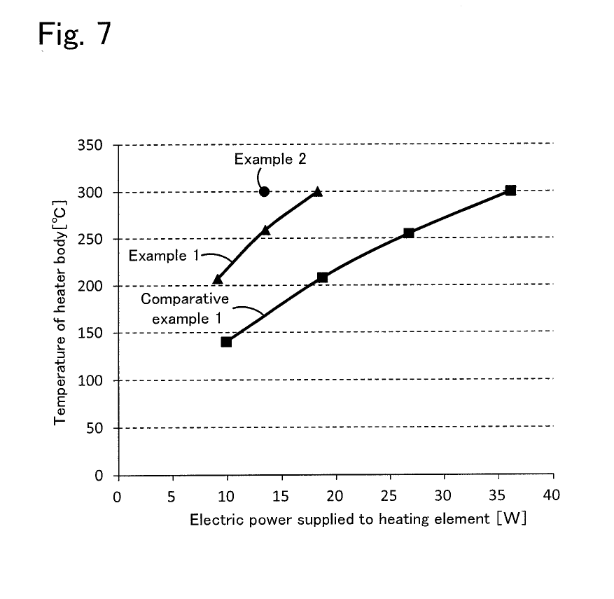

FIG. 7 is a graph showing the relationship between the electric power supplied to the heating element 13 and the temperature of the heater body in Examples 1 and 2 and Comparative Example 1. FIG. 7 shows that the temperatures of the heater bodies in Examples 1 and 2 are higher than that in Comparative Example 1 when the same electric power is supplied. With regard to the electric power required to increase the temperature of the heater body 11 to 300° C., the electric power required in Example 1 is about half the electric power required in Comparative Example 1. Also, the electric power required in Example 2 is about ¾ of that in Example 1 (about ⅓ of that in Comparative Example 1). A comparison between Examples 1 and 2 and Comparative Example 1, according to which the infrared heaters 10 have the same metamaterial structure 30, show that the energy efficiencies of Examples 1 and 2, in which the pressure in the interior space is reduced, are higher than that of Comparative Example 1, in which the pressure in the interior space is a normal pressure. In addition, a comparison between Example 1 and Example 2 shows that Example 2, in which the heater body 11 includes the low radiation layer 40, has a higher energy efficiency.

In Examples 1 and 2 and Comparative Example 1, the peak wavelength of the maximum peak of the heater body 11 was 6.7 μm, and the infrared radiation transmitting plate 54 was made of quartz glass (which transmits infrared radiation having a wavelength of 3.5 μm or less) for the convenience of the test. To efficiently emit the infrared radiation toward the object, the infrared radiation transmitting plate 54 is preferably made of, for example, fluorite (which transmits infrared radiation having a wavelength of 8 μm or less) so that the infrared radiation in a wavelength range including the peak wavelength at the maximum peak of the heater body 11 can be transmitted. When the infrared radiation transmitting plate 54 of the infrared heater is made of fluorite in the above-described Examples 1 and 2 and Comparative Example 1, the overall temperature of the heater body may be reduced. However, the relationship between Examples 1 and 2 and Comparative Example 1 is probably similar to the results shown in FIG. 7.

The present application claims priority of Japanese Patent Application No. 2016-207571 filed on Oct. 24, 2016, the entire contents of which are incorporated herein by reference.

What is claimed is:

1. An infrared heater comprising:
a heater body including a heating element and a metamaterial structure capable of emitting infrared radiation having a peak wavelength of a non-Planck distribution when thermal energy is supplied from the heating element; and
a casing having an interior space in which the heater body is disposed and whose pressure is reducible, the casing including an infrared radiation transmitting portion capable of transmitting the infrared radiation emitted by the metamaterial structure to an outside of the casing.

2. The infrared heater according to claim 1, further comprising:
an infrared radiation reflecting portion disposed apart from the heater body and capable of reflecting the infrared radiation toward at least one of the heater body and an object.

3. The infrared heater according to claim 2,
wherein the infrared radiation reflecting portion is disposed on an inner peripheral surface of the casing that is exposed in the interior space.

4. The infrared heater according to claim 2,
wherein the casing includes an infrared radiation transmitting member capable of transmitting the infrared radiation, and
wherein the infrared radiation reflecting portion is disposed outside the casing.

5. The infrared heater according to claim 4,
wherein the infrared radiation reflecting portion is disposed on an outer peripheral surface of the casing.

6. The infrared heater according to claim 1,
wherein the heater body includes a low radiation layer that is disposed on a surface of the heater body at a side opposite to a side at which the metamaterial structure is disposed when viewed from the heating element, the low radiation layer having an average emissivity lower than an average emissivity of the metamaterial structure.

7. The infrared heater according to claim 1, wherein the metamaterial structure includes a first conductor layer, a dielectric layer joined to the first conductor layer, and a second conductor layer, which are arranged in that order from the heating element, the second conductor layer including a plurality of individual conductor layers that are each joined to the dielectric layer and that are periodically arranged with gaps therebetween.

8. The infrared heater according to claim 1, wherein the metamaterial structure has a plurality of microcavities, at least surfaces of which are formed of a conductor and which are periodically arranged with gaps therebetween.
